(19) United States
(12) Patent Application Publication
(10) Pub. No.: US 2004/0059941 A1
(43) Pub. Date: Mar. 25, 2004

(54) Systems and methods for identifying users and providing access to information in a network environment

(75) Inventors: Todd Hardman, Orem, UT (US); James Ivie, Lindon, UT (US); Michael Mansfield, Lindon, UT (US); Greg Parkinson, Orem, UT (US); Daren Thayne, Orem, UT (US); Mark Wolfgramm, Provo, UT (US); Michael Wolfgramm, Pleasant Grove, UT (US); Brant Redd, Provo, UT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MyFamily.com, Inc., Orem, UT

(21) Appl. No.: 10/247,806

(22) Filed: Sep. 19, 2002

(51) Int. Cl. H04L 9/00

(52) U.S. Cl. 713/201

(57) ABSTRACT

Systems and methods for providing functions from a central facility on a computer network. One function facilitated includes authentication and authorization of users requesting access to a web server accessible via the communication network. Such authorization and authentication includes transferring a request for access from a content server to the central facility and authorizing the request from the central facility. Results of the authorization are communicated to the content server which displays the results of the request to the user by either allowing access or displaying a message describing a denied request.

### CROSS-REFERENCES TO RELATED APPLICATIONS

This application is being filed concurrently with related U.S. patent application Ser. No. ______ (Attorney Docket Number 019404-000720US), entitled “SYSTEMS AND METHODS FOR STORING AND RETRIEVING DATA IN A WEB SERVER ENVIRONMENT” and U.S. patent application Ser. No. ______ (Attorney Docket Number 019404-000730US), entitled “SYSTEMS AND METHODS FOR PARTITIONING DATA ON MULTIPLE SERVERS” which are incorporated herein by reference for all purposes.

### BACKGROUND OF THE INVENTION

This invention relates in general to systems and methods for accessing information from a network accessible web server. More specifically, this invention relates to systems and methods for authorizing and authenticating users requesting access to a web server. Yet further, the invention provides systems and methods for facilitating functions provided by a central service on a network.

Authorization and authentication are typically performed whenever access to a secure web server on a network is requested. In general, such authorization and authentication involves, querying a user for a user name (ID) and password, determining the identity of the user from the queried information, and providing the user with access to a network web server consistent with the user's rights. Upon authentication and authorization, the user is free access the web server associated with the network device.

This relatively simple approach requires that a user be authenticated and authorized for each secure web server which the user accesses. Thus, for example, a user wishing to access a second web server must again be authenticated and authorized before access to the web server is allowed. This redundancy is useful where a user's access is fundamentally different to the first and second web servers. However, where the two web servers recognize the same user for the same purposes, such redundancy is wasteful.

One simple solution to eliminate redundancy is to authenticate and authorize a user to access two or more web servers while providing only a single ID and password. For example, a user can be queried when accessing a first web server and upon authentication and authorization can be issued a “cookie” which indicates that the user is authorized to access other related web servers identified by the cookie. Such methods work well when both web servers share first and second level domain names. However, where the first or second level domain names are dissimilar, the method will not work.

In some instances, web server owners provide authorization and authentication via a central authorization facility often operated by a third party. Thus, for example, when a user accesses a requested web server, the user is redirected to the central authorization facility which queries the user for an ID and a password. Upon authorizing the user, the central authorization facility displays a message indicating status of any authentication and/or authorization. After displaying the message, the central facility redirects the user back to the requested web server.

In such a system, a user desiring access to a second web server is similarly redirected to the central authorization facility before access to the second web server is allowed. Thus, traffic to the central authorization server is very high. This is particularly inefficient where the user's access to both the first and the second web servers is identical.

In addition to the inefficiencies, confusing messages are often displayed to users when access to a web server is denied due to either failure of authentication or authorization. Such messages are displayed to the user by the central authorization facility. The messages are confusing because they do not reference the requested web server, but rather reference the central authorization facility. Such messages are particularly confusing to a user that is not aware that they were being redirected for authentication and authorization. In addition to confusing the user, a certain level of brand dilution results from displaying characteristics of the central authorization facility rather than the requested web server.

To avoid this confusion and brand dilution, many web server owners require the central authorization facility to display a failure message designed by the web server owner. While this alleviates problems with confusion and brand dilution, it is cumbersome and labor intensive. Frequently, providers of the central authorization facility use different tools to author and host their web pages than providers of an associated web server. So, providers of the web server must learn to author using different tools. In addition, whenever a design change is made to the web server, matching changes must be made on the pages served by the central authorization facility.

Thus, there exists a need in the art for systems and methods for providing third party services, which are transparent to the user. In addition, there exists a need in the art for systems and methods for providing a one time authorization and access to a family of web servers.

### BRIEF SUMMARY OF THE INVENTION

The present invention provides systems and methods for using functions available from a central facility in communication with a computer network. In some embodiments, the functions provided by the central facility include authenticating a user requesting access to a web server. In other embodiments, the functions provided by the central facility include authorizing the user. In addition to authenticating and authorizing a requesting user, the systems and methods of the present invention are applicable to a number of other functions provided by a central facility.

One embodiment of the present invention includes methods for providing functions from a central facility associated with a computer network. The methods include receiving a request to access a content server. The content server refers at least a portion of the request to the central facility, which executes the request. The results of the execution are indicated to the content server, which in turn displays the results of the request. Because the content server generates the displayed message, any changes to the message can be made without accessing the central facility. Further, by generating the message from the content server, brand dilution is eliminated without the complexity and expense associated with maintaining and updating displays on the central facility.

In some embodiments, the function performed by the central facility is an authentication function. Such a function can include comparing a user name and password with a known user name and password maintained at the central facility. The authentication function can authenticate a user to access two or more servers each associated with different second-level domain names. Such authentication reduces traffic to the central facility and eliminates the need for a user or device to be authenticated for each server individually.

Another embodiment of the present invention includes a system for providing web server related functions via a central facility. The system includes at least two web servers connected to a central facility via a computer network. In the system, a message indicating failure of a function performed by the central facility is maintained on one of the web servers and another message indicating failure of a function performed by the central facility is maintained on the other web server. In this way, brand identity associated with the first and the second web servers can be maintained without providing failure messages to the central facility.

Yet another embodiment of the present invention includes a method for authenticating a user to a computer in communication with a computer network. The method includes receiving an access request at a first content server. The access request is referred to a central facility where the request is executed. A response to the executed request is received and indicated in the form of a cookie associated with first content server and in the form of a cookie associated with the central facility.

In some embodiments, the first content server is associated with a first domain name and the second content server is associated with a second domain name. A second level of both the first and the second domain names are different.

These and other embodiments of the present invention are described in more detail in conjunction with the text below and attached figures.

### BRIEF DESCRIPTION OF THE DRAWINGS

A more complete understanding of the present invention may be derived by referring to the detailed description and claims when considered in connection the figures, wherein like reference numbers refer to similar items throughout the figures, and:

FIG. 1 illustrates a web server environment according to the present invention;

FIG. 2 illustrates a flow diagram describing authentication using a central facility according to the present invention; and

FIG. 3 illustrates a flow diagram of an embodiment of the present invention used in relation to a variety of aspects related to a user login.

### DETAILED DESCRIPTION OF THE INVENTION

The present invention provides systems and methods for using functions available from a central facility in communication with a computer network. In some embodiments, the functions provided by the central facility include authenticating a user requesting access to a web server. In other embodiments, the functions provided by the central facility include authorizing the user to access portions of a particular web server. In addition to authenticating and authorizing a requesting user, the systems and methods of the present invention are applicable to a number of other functions provided by a central facility. Such additional functions can include, but are not limited to, updating a user's information on the system and creating new users on the system.

A fundamental advantage of the World-Wide Web over predecessor online services is the opportunity to link from content on one web site to content on another. A new trend on the Internet is to use these same facilities to integrate services on the Internet. For example, email services for a web site might be outsourced to a vendor that specializes in providing email services.

As services like these are outsourced, they must be privately branded so that the user has a consistent experience. Even though services may be sourced from different hosting centers in different places, the integration should appear as one service to the user. This invention provides systems and methods related to manage and provide web pages under pseudo control of a central facility. The present invention advantageously allows the provider of a web server using a central facility to author messages associated with the central facility using the same tools used for its own web server pages. Additionally, the present invention allows a provider of a web server greater control over a user's experience with the web server.

It will be appreciated by one of ordinary skill in the art that the systems and methods of the present invention can be used in relation to various outsourced functions including, but not limited to, stock quotes, authorization requests, authentication requests, registration for events or services, and status inquiries (e.g., email messages received). The present invention can be used in relation to outsourced functions for either human users or devices capable of communicating with a central facility. For example, systems and methods of the present invention can be used to update information related to a scanner which can be used to upload pictures to a web server.

For the purposes of this document, authentication is a process whereby the identity of a user and/or device is acknowledged. Thus, as a simple example, authenticating may involve receiving an ID and a password from a user and using the received information to determine the identity of the user. Once a user is authenticated, the user can then be authorized. Such authorization includes identifying rights which a user has to access a particular web server. For example, a user can be authorized to both read and write a database associated with one web server, while only being authorized to read a database associated with another web server.

Also, for purposes of this document, a Uniform Resource Locator (URL) is the address of a page or program on the World-Wide Web. For example, the URL for Yahoo is “http://www.yahoo.com”. The most common forms of URLs include a protocol (indicating the way to communicate), a host name (indicating the name of the computer to access), a path (indicating the resource) and an optional query string (indicating information to be supplied to the resource). For example: “http://www.myfamily.com/exec?c=site&htx=main”. In this example the protocol is “http”, the host name is “www.myfamily.com”, the path is “/exec” and the query string is “c=site&htx=main”.

HyperText Markup Language (HTML) is the language used for marking up text for display as a page on the world-wide web. It consists of text with embedded markup tags. A “form” is a special type of web page. Like all web pages it is marked up in HTML. But, a form includes special tags that allow the user to enter or select information. For example, it might include a text entry field into which a user enters their name, or it might include buttons to select among a set of options.

HyperText Transfer Protocol (http) is the protocol that Web Browser programs (also known as User Agents) use to communicate with web servers on the Internet. In a typical interaction, the browser requests a page at a URL and the web server returns the corresponding HTML page.

A request in the HTTP protocol can be made in a number of different ways, but the most common methods are “GET” and “POST”. In a GET request, the browser simply provides the URL as above. Alternatively, in a POST request, the browser supplies the URL and additional information, such as a user name and password appended to the URL. In most cases, the additional information is information that a user entered into an HTML form.

In general, when a web server receives a request, it sends back a response. Such responses can start with a response code, such as, the number 200, which indicates that the request was successful. In addition, the response usually includes an English-language comment such as “OK”, which is generally ignored by the browser. The balance of the response is typically an HTML web page.

Another common response is a redirect. Common redirect responses begin with response codes 302 or 303. Such redirect responses include a new URL indicating that the browser should make a new request to the specified URL. Redirect responses are often used with POST requests. Thus, when a web server receives a POST request, it generally processes the form data that was sent in the request and subsequently returns a redirect response to direct the browser to the next page a user should see.

This method is very convenient for web programmers. In a typical configuration, the web server executes a special program, called a CGI, when it receives a POST request. If a redirect is not used, the CGI program must process the form data and it must render the new web page. With a redirect, the CGI can process the form and let the new web page be supplied by conventional means.

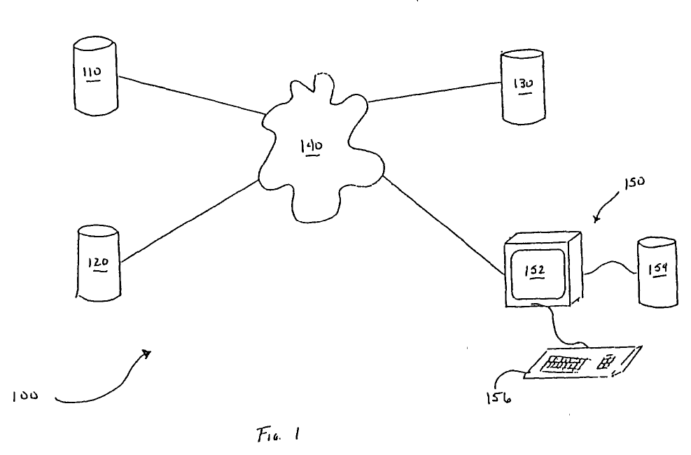

FIG. 1 illustrates an embodiment of a web server environment 100 comprising a content server 110, a content server 120, a central facility 130 and an access device 150. Each of the content servers 110, 120, central facility 130 and access device 150 are in communication with a network 140. Access device 150 can include a display 152, a database 154 and a data entry device 156.

In one particular embodiment, network 140 is the Internet and access device 150 is a personal computer (PC) comprising an Internet Browser (not shown) for communicating via network 140. In some embodiments, content servers 110, 120 and central facility 130 are web servers which include both software and hardware components necessary for communicating across network 140. Of course, one of ordinary skill in the art will recognize that the present invention is applicable to a number of environments. For example, the present invention is applicable to a virtual private network comprising content server 110, central facility 130 and access device 150 in communication with network 140.

The systems and methods of the present invention are suited to communication between content servers 110, 120, central facility 130 and access device 150. In an embodiment, such systems and methods provide for application software running on access device 150, such as a photo uploader, to access content servers 110, 120 and upload a desired photograph. Prior to accessing content servers 110, 120 a user associated with access device 150 is authenticated to content servers 110, 120 and/or authorized to access the desired content server.

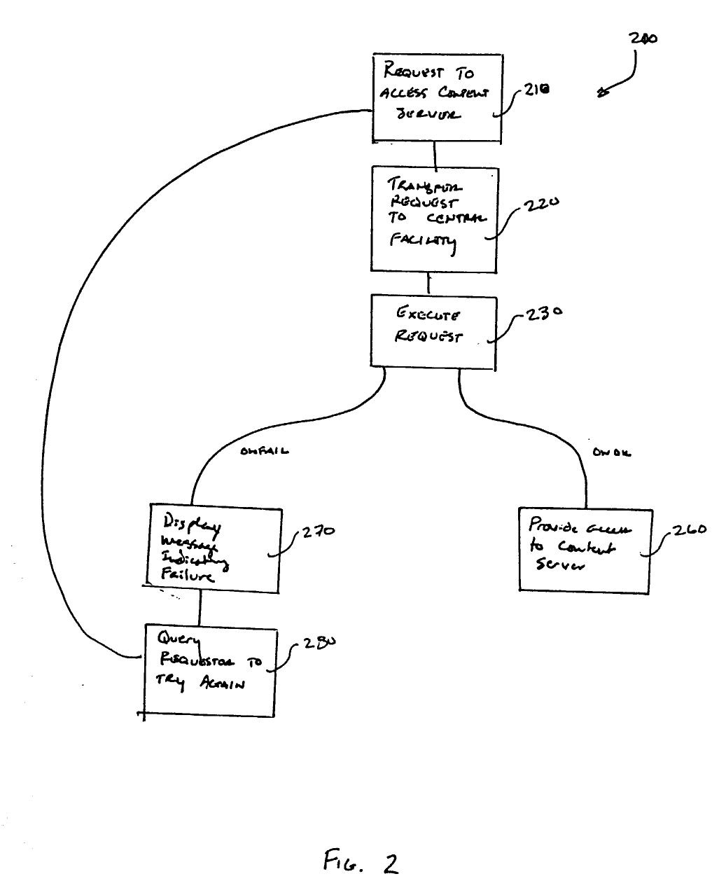

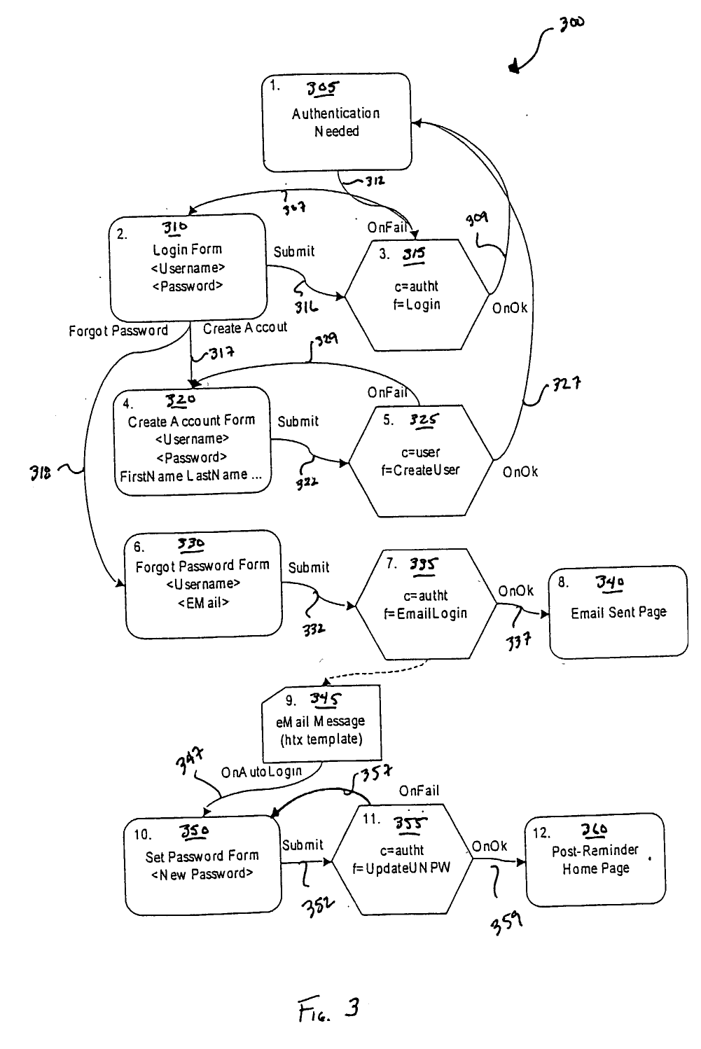

Such authentication and/or authorization is provided by way of a Central Authentication Protocol (CAP) according to the present invention. In some embodiments of the present invention, both authentication and authorization are performed according to the CAP. In other embodiments, only authentication or authorization is performed according to the CAP. In one particular embodiment, authentication is performed according to the CAP, while content servers 110, 120 each individually perform authorization. Embodiments of the CAP are described in relation to FIGS. 2 and 3.

FIG. 2 illustrates an embodiment of the CAP according to the present invention. In the embodiment, a request to access content server 110 is received (step 210). The request for access can be received from access device 150, or from another server, such as content server 120. In one embodiment, the request is initiated by a user viewing a web page, such as, www.hypotheticalONE.com/home maintained on content server 110. Wishing to log in, the user selects a link marked “login” on the page.

In response to the request for access (step 210), content server 110 transfers the request to central facility 130 by redirecting the user to the URL for the “login” page of central facility 130. For example, a user can be directed to the following exemplary URL:

http://www.centralfacility.com/login.cgi?onok=http%3A%2F%2Fwww.hypotheticalONE.com% 2Fmain&onfail=http%3A%2F%2Fwww.hypotheticalONE.com%2Flogin.

In this example, the user is directed to the “login” page of www.centralfacility.com which is maintained on central facility 130. Once at central facility 130, the user is authenticated. Embedded within the exemplary URL are two additional URLs specified within the query string. The “onok” URL, www.hypotheticalONE.com/main,

is the page to which the browser should be sent upon successful authentication. Alternatively, the “onfail” URL, www.hypotheticalONE.com/login is the page to which the browser should be sent if authentication fails. In the embedded URLs, the special characters, colon and slash, are replaced by “%3A” and “%2F” respectively. This is known as “URL encoding” and is a standard method used when passing data in URLs to avoid ambiguity on how a character should be interpreted. It should be recognized by one of ordinary skill in the art that other forms of URL encoding and/or embedded URLs can be used according to the present invention.

In the situation where the user has previously logged in to the server, central facility 130 automatically redirects the user to the “onok” URL where the user is then allowed to access content server 110. As discussed below, in some embodiments a user's prior login is indicated by a cookie resident on the user's database 154. Advantageously, a user who has been previously authenticated by central facility 130 can be automatically authenticated for another content server. For example, a user who previously logged into content server 120 can be automatically authenticated to access content server 110.

In the situation where the user has not previously logged in, the browser is redirected to the “onfail” URL. In the exemplary URL, the “onfail” URL is a login page maintained on content server 110. Thus, the user is prompted for login information by a message displayed to the user from content server 110. Advantageously, the user sees a message displayed from content server 110 and not from central facility 130. This allows the provider of content server 110 to avoid brand dilution and eliminates confusion resulting from a user being denied access by a foreign central facility 130.

In addition to redirecting the user's browser to the “onfail” URL, central facility 130 can add information to the query string of the “onfail” URL which indicates why the user is being returned to the “login” page. For example, central facility 130 can add a message “please enter your user name and password”. Content server 110 can incorporate this information in a message presented to the user or ignore the information and present another message.

In some embodiments, the message associated with the “onfail” URL queries the requesting user or device for identification information. For example, in some embodiments, content server 110 displays a data entry interface or form on display 152 requesting a user name and password. In some embodiments, the requested identification information is passed from a browser resident on access device 150 to central facility 130 (step 220). Alternatively, in other embodiments, the requested identification information is passed to content server 110 which in turn passes the information to central facility 130 (step 220).

The request is executed by central facility 130 (step 230). Where a user entered incorrect identification information, the user can be automatically redirected back to the login page where a message indicating the failed attempt is displayed (step 270) and where the user can be prompted to re-enter the identification information (step 280). Thus, for example, the user could be redirected to the “onfail” URL, www.hypotheticalONE.com/login. In some embodiments, central facility 130 redirects the user's browser to the “onfail” URL and additionally includes a query string, such as, “code=badpassword” appended to the “onfail” URL. The message displayed to the user by content server 110 may use the query string to tailor a message to the user's particular needs. For example, based on the query string, content server 110 may display the message “Invalid user name or password. Please try again.” The following is an example of such an “onfail URL with an added query string:

www.clientapp.com/login.htm?code=badpassword.

Where execution of the request (step 230) finds that the user entered a correct user name and password, the user is automatically redirected to the “onok” URL, www.hypotheticalONE.com/main (step 260). An Authentication Token (ATT) is passed to content server 110 as a query string embedded in the “onok” URL. Based on the ATT, the user is granted access to content server 110. In addition, the ATT is written as a cookie to database 154.

The ATT can be string of characters that encode binary information which indicates the successful authentication. For example, the ATT may be the string “ABC123” which is written as a cookie to database 154 and appended to the “onok” URL. Thus, the “onok” URL is www.hypotheticalONE.com/main.htm?credential=ABC123. Upon reception of the ATT, content server 110 displays the main information page to at display 152 (step 260).

In some embodiments, upon receiving the ATT as an appended query string, content server 110 writes the ATT as a cookie to database 154. With the cookie in place on database 154, the user does not need to be authenticated for subsequent accesses to content server 110. Additionally, the cookie allows the user to access other content servers which share common first and second level domain names with content server 110. Thus, for example, where the URL for content server 120 is sales.hypotheticalONE.com, a user authenticated to access content server 110 (URL www.hypotheticalONE.com) would also be authenticated to access content server 120.

Because the ATT is also issued as a cookie by central facility 130, the user is additionally authenticated to central facility 130 and other content servers which share common first and second level domain names with central facility 130. Thus, for example, where the URL for content server 120 is xyz.centralfacility.com, the cookie would allow the user to access content server 120.

Thus, in some embodiments, successful authentication results in a cookie associated with content server 110 and central facility 130 being written to database 154. These cookies can be queried whenever a user or device accesses either content server 110, central facility 130, or other servers sharing common top level domain names to determine if authentication has been completed. These cookies can be either persistent or time-limited. Persistent cookies expire on a particular date and time and often rarely need to be renewed. Alternatively, session cookies do expire after the occurrence of a particular event, such as a logout. Once a session cookie expires, the user is required to authenticate again. By maintaining such cookies on a user's database, the user can be quickly and efficiently authenticated and authorized to a particular server.

Where the ATT is included in a cookie resident on the user or device's database, a browser will automatically present it to any other server on that domain, such as, www.hypotheticalONE.com or sales.hypotheticalONE.com and so forth. Therefore, servers needing the identity of a user that are on the hypotheticalONE.com domain can just check the cookie to determine whether the user has logged in and obtain the user's identity.

In addition, some embodiments of the CAP make use of Authorization Tokens (AZT) similar to the way ATTs are used. While ATTs indicate that a user is authenticated, the AZTs indicate which portions of a server a user is authorized to access and what level of access is possible.

ATTs and AZTs grant authentication and authorization only for the duration of the user's browser session. In addition, an ATT can incorporate an expiration date and time after which it becomes invalid. In some embodiments, cryptographic protection of an AZT incorporates a hash of a corresponding ATT. This ties the AZT to a particular ATT. Thus, if the ATT expires or is changed in any way, the AZT is invalidated by the absence of a valid ATT that matches the hash code.

In other embodiments, an AZT incorporates its own expiration date and time and is entirely independent of the presence of an ATT. Yet other embodiments involve ATTs and AZTs which each include the date and time of issuance. In such embodiments, each client service can independently set a standard for how old an ATT or AZT can become before it is considered expired.

In a particular embodiment an ATT and AZT are protected using a Message Authentication Code (MAC) as described in Internet RFC 1828. A MAC is a hash value calculated using the contents of a message and a secret key. If the contents of the message change in any way, a different MAC value will result. Since the MAC can only be calculated by a system possessing the secret key, any attempt to manipulate the contents of the ATT or AZT will result in an invalid MAC value. Using a MAC, the contents of ATTs and/or AZTs are protected against tampering, without requiring encryption. Thus, there are no legal export restrictions despite the fact that strong 128-bit keys are in use.

For the ATT, the MAC value is calculated using a secret key and the contents of the ATT. Then the MAC value is appended to the end. This means that a valid ATT can only be calculated by a system that has a copy of the secret key.

The AZT can also be protected by a MAC but, in this embodiment, the inputs to the MAC are a different secret key, which incorporates the contents of the ATT and the AZT. The calculated MAC value is appended to the AZT. Thus, if the ATT changes in any way—such as when a different user logs in—the AZT automatically becomes invalid because the calculated MAC changes.

Some embodiments use “symmetric keys”, that is, the system generating the MAC values uses the same keys as the system testing them. Alternative embodiments use digital signatures which are like MACs except that they use the RSA public key encryption algorithm. The use of digital signatures enables the use of different keys on the systems that generate the ATT and AZT from the keys used on the systems that test the ATT and AZT potentially improving security. However, the digital signature method requires much more computation which could potentially damage performance.

Another embodiment involves encrypting the contents of the ATT and AZT rather than using a MAC or digital signature. Encryption could use symmetric keys or public key encryption. If encryption is used, the contents of the AZT would include a hash of the ATT since no MAC or digital signature exists. This hash should use a cryptographically secure algorithm such as MD5 or SHA.

As discussed, ATTs and/or AZTs can be passed as query strings. For example, XML Formatted API requests can pass ATTs as request and response parameters similar to other passed parameters. However, like cookies that persist for the length of time, an ATT will persist between requests within the same XML document. This allows an ATT passed in the first request in an XML document to remain valid in all succeeding requests. Also, requests that generate or update an ATT will automatically pass those values to succeeding requests in the same XML document.

In some embodiments, the user name and password from a prior failed attempt to authenticate are stored on content server 110. If a subsequent attempt to authenticate uses an identical user name and password, the process of flow diagram 200 is not repeated as it would provide the same result. Alternatively, a browser and/or central facility 230 may be configured to avoid resubmission of the same failed user name and password. This advantageously avoids unnecessary traffic and/or execution by central facility 130.

Of course, it should be recognized by one of ordinary skill in the art that central facility 130 may include content pages for various web servers. Such content may be maintained, for example, to assure backward compatibility or to provide special features.

In light of the preceding example of the present invention, one of ordinary skill in the art will recognize a number of advantages. For example, content server 110 is able to make use of central facility 130, but central facility 130 need not display any pages or other visual content to display 152 for the user to view. Instead, central facility 130 redirects the user's browser to an appropriate page supplied by content server 110. Advantageously, this allows an operator of content server 110 to retain full control of the look and feel and the user's experience without requiring cumbersome and costly interaction with central facility 130.

It should be recognized by one of ordinary skill in the art that previously discussed error codes, such as, “badpassword” are simply codes to be interpreted by content server 110. Therefore, such codes may easily be replaced with error code numbers or any other code capable of indicating an error condition to content server 110. By simply indicating an error condition to content server 110, the actual text of any error message can be controlled by content server 110. This degree of control is particularly advantageous for developing systems that support multiple languages.

Using systems and methods according to the present invention, if an operator decides to change web pages generated from content server 110, all pages to be changed remain on the operator's servers and can be deployed using the operator's preferred authoring and hosting tools. It is not necessary for the operator to make any changes to content maintained on central facility 130.

Also, according to the present invention, a number of different content servers can be associated with central facility 130. Because of this, a user need only authenticate once using central facility 130 to gain access to all other associated web servers.

Each of the content servers associated with central facility 130 can include its own branding. This branding is preserved by serving messages derived from execution of functions on central facility 130 from associated content servers.

Procedures similar to those discussed in relation to flow diagram 200 can be followed to access a number of functions available from central facility 130. For example, the following URL can be used to logout a user according to the present invention:

http://www.myfamily.com/exec?c=autht&f=logout&onok=http://www.hypotheticalONE.com/exit

Similar to the discussion of the login function, the preceding logout URL calls the authentication component, autht, of central facility 130. However, the “f=logout” function is called to log a user or device off the system. Upon completion of the logout procedure, a user is automatically redirected to the “onok” URL, which, in some embodiments, causes a login display to appear on display 152. Similar to the login function previously described, the login display is produced from content server 110.

In some embodiments, the ATT created in association with a login function is destroyed upon execution of the logout function, which effectively logs a user off the system. Where cross-domain login was used, such as where a user is authenticated for both content servers 110, 120, it is possible that ATTs for other domains will still exist allowing access to those domains. Thus, to complete logout, the remaining ATTs should be destroyed. In one particular embodiment, such destruction of the cross-domain ATTs is accomplished by forcing a closure of the browser. By closing the browser, all session cookies are destroyed.

Again, a similar procedure is followed to create a new user identity on the system. For example, the following URL is provided to create a new user identity:

http://www.hypotheticalONE.com/exec?c=user&f=create&onok=http://www.hypotheticalONE com/enter&onfail=http://www.hypotheticalONE.com/exit

The preceding URL calls the “user” component of central facility 130 in order to create a new user identity on the system. Thus, the function called is “f=create”. Upon successfully creating a new user, a user is automatically redirected to the “onok” URL, which, in some embodiments, is the entry point for the domain accessed. Alternatively, if creating the user is unsuccessful, a user is automatically redirected to an exit point for the domain accessed. At the exit point, a display can be produced requesting the user to correct any errors related to creating a new user identity. Such errors can include, but are not limited to, the selected user name already having been assigned to another user, two copies of a desired password do not match, and the password does not meet standards of length and reserved/required characters. In some embodiments, the aforementioned password problems are detected by the browser or by either content servers 110, 120. In this way, traffic to central facility 130 can be minimized.

A failure to create a new user can be indicated by appending a parameter on the end of the exemplary URL. Such an indication of failure can optionally include a suggested alternate user name. The alternate user name can be displayed to the user by the appropriate content server 110, 120. The user can choose to select the alternate name, or enter a different name.

Yet other functions may be performed by central facility 130 in addition to authentication and account creation. For example, central facility 130 can be used for, among other things, updating user records including, but not limited to, user names and passwords. Additionally, central facility 130 can be used to test ATTs, selecting a user, deleting a user, getting user names, listing users, listing sites to which particular users are authorized, listing users currently accessing a site, creating and/or updating a gift list related to a user, and other such functions.

Within query strings, most numbers are passed in decimal format. The few exceptions are in hexadecimal and are marked as such with the “0x” prefix. Floating-point numbers use the period “.” for the decimal point. Further, dates are formatted according to the ISO 8601 standard which is the following: “CCYY-MM-DD” in which “CC” represents the century, “YY” represents the year, “MM” represents the month (01 is January), and “DD” is the day of the month. For example “1776-07-04”. Times are also formatted according to ISO 8601 as follows: “HH:MM:SS” where “HH” is hours, “MM” is minutes and “SS” is seconds. Times are always in 24-hour format. For example: “18:30:25”. A timezone may also be appended. For example: “18:30:25-05”. Consistent with ISO 8601, date and time can be concatenated. The standard indicates that the letter “T” should be used to separate the date from the time.

In some embodiments where dates and times do not exactly match ISO 8601, a best effort attempt is made to parse the date using American English standards. For example, “Jul. 4, 1776” would be accurately parsed. “7/4/1776” would be interpreted as “Jul. 4, 1776” and not “7 Apr., 1776”. However, in general, it is best to follow the 8601 standard to avoid misinterpretation.

FIG. 3 illustrates a flow diagram 300 of an embodiment of the present invention used in relation to a variety of aspects related to a user login. A page is generated from content server 110 including a login selector for logging into content server 110 (block 305). A user selects the login selector and the user's browser is automatically redirected to central facility 130. The login function, “f=login”, of the authentication component, “c=autht”, of central facility is called to authenticate the user (block 315). If the user has been previously authenticated, the user is automatically redirected back to content server 110 (step 309). In some embodiments, prior authentication is determined by the presence of a cookie previously written by central facility 130 to the user's database 154.

If a user has not been previously authenticated, the user's browser is automatically redirected to a login form 310 generated from content server 110 (step 307). On the login form, the user is queried for identification information, such as, a user name and password. The user can either submit the queried information (step 316), indicate an intention to create a new user account (step 317), or indicate that the identification information has been forgotten (step 318).

Where the user submits the queried information (step 316), the queried information is automatically directed to central facility 130. The login function, “f=login”, of the authentication component, “c=autht”, of central facility processes the submitted identification information (block 315). Where the user is successfully authenticated using the submitted authentication information, the user's browser is automatically redirected to content server 110 (step 309). Alternatively, where the user cannot be authenticated using the submitted identification information, the user's browser is automatically redirected to login form 310 generated from content server 110 where they are again queried to enter identification information (step 307).

Where a user indicates that a new account is to be created (step 317), a create account form 320 is generated from content server 110. New account form 320 queries the user to select a user name and password and also asks the user to provide personal information, such as, names, phone numbers, emails, and the like. Having provided the queried information, the user submits it (step 322). The CreateUser function, “f=CreateUser”, of the user component, “c=user”, of central facility 130 processes the submitted personal information. (block 325). In some embodiments, such processing is limited to determining if the selected user name and password are unique and then recording the selected user name and password. Where the selected user name and password are unique, the user is automatically logged into the system and redirected to content server 110 (step 327). Alternatively, where the selected user name and password are not unique, the user's browser is automatically redirected to the create account form 320 where the user is queried to select a different user name (step 329).

Where a user indicates that the user name and/or password are forgotten (step 318), forgotten password form 330 is generated from content server 110. Forgotten password form 330 queries the user to enter their user name and/or email address. Having provided the queried information, the user submits it (step 332). The email login function, “f=EmailLogin”, of the authentication component, “c=autht”, of central facility 130 processes the submitted email and/or username information (block 335). The user is automatically redirected to an email sent page 340 generated from content server 110 (step 337).

In addition, where the username and/or email address is successfully associated with a password, an email message is produced and sent to the user's email address (block 345). In some embodiments, the email message includes a hyper link which provides access to content server 110 (step 347). Selecting the link causes content server 110 to generate a set password form 350 for display on monitor 152. Set password form 350 queries the user to select a new password. Having entered the new password, the user submits it (step 352). The new password is automatically redirected to an update password function, “f=UpdateUNPW”, of the authentication component, “c=autht”, of central facility 130 (block 355). If the new password fails for any reason, the user is automatically redirected back to set password form 350 generated from content server 110 (step 357). Alternatively, if the password is a success, the user is automatically redirected to an access page 360 generated from content server 110 (step 359).

The present invention provides various methods and systems for authenting and/or authorizing users. For example, one process of authentication involves a request from a browser for a a particular content page from content server 110. Content server 110 requires authentication in order to deliver the page so it returns a redirect, which directs the browser to obtain authentication from central facility 130. The browser requests an ATT from the authentication function of central facility 130. Where central facility 130 does not have any acceptable credential from the browser (session cookie, persistent cookie, or other authentication method), it redirects the browser to a branded login page on content server 110. The browser then requests the branded login page from content server 110 and in return, content server 110 returns the branded login page.

The browser presents the login page to a user, which, in some embodiments, is a form requesting a username and password. Further, it may include links to corporate information, customer service, and password recovery (forgotten password) pages. The user types in his/her username and password into the branded login page. The branded login form designates the authentication function of central facility 130 as its destination. Therefore, the browser submits the username and password specified by the customer to the authentication server. The authentication function of central facility 130 verifies the username and password and if correct, returns an ATT to the browser, as well as, redirecting the browser back to the originally requested content page. In some embodiments, the ATT is always returned as a cookie. But if central facility 130 and content server 110 do not share a second-level domain, the ATT is also appended to the redirection URL.

If the username and password are incorrect, the central facility 130 redirects the browser back to the login page so that the user can try again. In this case, it appends an error code to the URL, which content server 110 can translate into an appropriate message when presenting the login page.

Upon authentication, the browser requests the same content page it initially requested. This time it includes the ATT either as a cookie or on the URL. Content server 110 tests the ATT for validity and returns the requested content page. If the ATT was passed on the URL, content server 110 returns it as a cookie for the benefit of future requests. The browser then presents the content page to the user.

In some embodiments, all authentication information (e.g. username and password) passes from the browser directly to central facility 130. Content server 10 does not “see” this information. Further, in some embodiments, all communication between the central facility 130 and content server 110 uses the user's browser as an intermediary. The information is carried back and forth in the form of URLs and cookies. In varius embodiments, content server 110 can communicate directly with central facility 130 to retrieve and/or update personal profile information (such as name, address, etc.) When doing so, content server 110 uses the ATT to authorize access. Thus, access is only permitted to information about users that have active authenticated sessions.

In some embodiments where the user is previously authenticated by central facility 130 (probably at the request of some other content server), if central facility 130 and content server 110 share a second-level domain, content server 110 can detect this since cookies are shared across the second-level domain. Alternatively, where content server 110 and central facility 130 do not share second-level domain names, the user must be authenticated. Such authentication includes a request by the browser for a particular content page from content server 110. Content server 110 requires authentication in order to deliver the page so it returns a redirect redirecting the browser to obtain authentication from central facility 130. The browser requests an ATT from the authentication function of central facility 130. Since the user has already authenticated, central facility 130 detects a valid ATT in a browser cookie. If the ATT is nearing expiration, the central facility 130 renews it. Regardless, central facility 130 redirects the browser back to the original content page on the content server. In doing so, it appends the ATT to the URL. Then, the browser requests the same content page initially requested and this time includes the ATT in the requesting URL.

Content server 110 tests the ATT for validity and returns the requested content page and the browser displays the page. If the ATT was passed on the URL, content server 110 returns it as a cookie for the benefit of future requests.

As mentioned, the present invention can be used to authorize users. IN one embodiment of authorization, the browser requests a particular content page from content server 110. Content server 110 requires authorization in order to deliver the page so it returns a redirect redirecting the browser to obtain authorization from the authorization function of central facility 130. The browser requests an AZT from central facility 130, however, before the authorization function of central facility 130 can determine whether the user should have access, it must know who the user is. Thus, where the user is not yet authenticated, the browser is redirected to obtain an ATT as described above.

After obtaining the ATT, the browser again requests an AZT from the authorization function of central facility 130. This time, central facility 130 detects the ATT and looks in its database to determine whether the user is authorized to access the requested content. If so, central facility 130 issues an AZT and redirects the browser back to the original content page. As with the ATT, the AZT is issued as a cookie and, if second-level domains are not shared, it is appended to the redirect URL.

Thus, a user can be authenticated but still not be granted access to restricted content. In this case, the browser would be redirected to an error page on content server 110. The error page might simply inform the user that access is denied or it might include a solicitation to subscribe to the requested content.

The browser requests the same content page it initially requested, however, this time it includes the AZT. Content server 110 tests the AZT for validity and returns the requested content page and the browser presents the content page to the user. If the AZT was passed on the URL, it returns it as a cookie for the benefit of future requests.

In light of the preceding discussion several advantages of the present invention are evident. For example, the present invention provides systems and methods for using a central facility to perform functions related to content databases in communication with a network. The present invention advantageously provides a mechanism for a content servers 110, 120 to display results from functions executed by a central facility 130. By displaying the results from content server 110, 120, brand dilution is eliminated without requiring a display message to be uploaded and maintained on central facility 130.

Although the invention is described with reference to specific embodiments and figures thereof, the embodiments and figures are merely illustrative, and not limiting of the invention. Rather, the scope of the invention is to be determined solely by the appended claims.

What is claimed is:

1. A method for providing functions from a central facility associated with a computer network, the method comprising:
receiving a request at a content server;
referring at least a portion of the request to the central facility, wherein the portion of the request is provided to the central facility as an http request, and wherein the central facility executes the request and indicates a request status to the content server; and
wherein a message indicating the request status is generated by the content server.

2. The method of claim 1, wherein the request is executed by one of a plurality of a functions provided by the central facility.

3. The method of claim 2, wherein the request comprises a datum upon which the function operates.

4. The method of claim 1, wherein the request is a request to access the content server.

5. The method of claim 4, wherein the request to access the content server comprises a request to authenticate and a request to authorize.

6. The method of claim 4, wherein the request to access the content server comprises a request to authenticate a requestor, and wherein execution of the request by the central facility comprises comparing an identification of the requestor with a known identification.

7. The method of claim 6, wherien the identification of the requestor is provided by a user's browser to the central facility, and wherein the content server is blind to at least a portion of the identification of the requestor.

8. The method of claim 7, wherien any communication between the content server and an authentication function of the central facility is accomplished through the user's browser.

9. The method of claim 4, wherein the message indicating the request status indicates that the request failed.

10. The method of claim 4, wherein the message indicating the request status comprises a request for additional information.

11. The method of claim 4, wherein the message indicating the request status indicates that the request succeeded.

12. The method of claim 4, wherein the message indicating the request status queries the requestor for additional information.

13. The method of claim 1, the method further comprising:
receiving the request status indicated by the central facility across a computer network.

14. The method of claim 4, wherein the content server is a first content server associated with a first domain name, the method further comprising:
providing a second content server associated with a second domain name, wherein the second level of the first and the second domain names are different; and
wherein the message indicating the request status is provided to the first content server and a cookie is provided indicating authentication for access to the second content server, wherein a user or device is authenticated to access both the first and the second content servers.

15. The method of claim 14, wherein the cookie is provided by the central facility.

16. The method of claim 14, wherein the central facility is associated with a third domain name, the second level of the third domain name being the same as the second level of the second domain name.

17. A system for providing web server related functions via a central facility, the system comprising:
a first web server and a second web server;
both the first and the second web servers connected to a central facility via a computer network; and
wherein a first status message indicating failure of a function performed by the central facility is maintained on the first web server and a second status message indicating failure of a function performed by the central facility is maintained on the second web server, and wherein the first and the second status messages are accessed by redirection associated with an http request to the central facility.

18. The system of claim 17, wherein the first web server is associated with a first domain name and the second web server is associated with a second domain name, and wherein a second level of the first and the second domain names are different.

19. The system of claim 17, wherein the first status message comprises a characteristic of the first web server.

20. The system of claim 19, wherein the first characteristic comprises a trademark associated with the first web server or a product offered thereon.

21. The system of claim 19, wherein the second status message comprises a characteristic of the second web server, and wherein the characteristic of the first web server is different than a characteristic of the second web server.

22. A method for authenticating a user to a computer in communication with a computer network, the method comprising:
receiving a request to access a first content server;
referring the access request to a central facility, wherein the central facility executes the request, writes a second cookie to a requestor's database allowing the requestor to access a second content server, and indicates the status of the request to the first content server; and
writing a first cookie associated with the first content server to the requestor's database allowing the requestor to access the first content server.

23. The method of claim 22, wherein the first content server is associated with a first domain name and the second content server is associated with a second domain name, and wherein a second level of the first domain name is different than a second level of the second domain name.

24. The method of claim 22, the method further comprising:
maintaining a message indicating a status of the access request on the first content server; and
upon receiving a response to the access request, displaying the message indicating the status of the access request from the first content server to the requestor.

25. The method of claim 24, wherein the message indicating the status comprises a characteristic of the first content server.

26. The method of claim 25, wherein the requestor is prevented from knowing that the request was denied by the central facility.

27. The method of claim 23, wherein the access request comprises a request to both authenticate and authorize a requestor.

28. A method for authenticating a user requesting access to a database associated with a web server in communication with the Internet, the method comprising:
receiving an access request at a first content server;
referring the access request from the first content server to a central facility;
receiving a response to the access request at the first content server; and
indicating the response to the access request in the form of a cookie associated with the first content server and a second content server.

29. The method of claim 28, the method further comprising:
authenticating with the central facility, wherein authentication information is provided to the central facility and the first content server remains blind to at least a portion of the authentication information.

30. The method of claim 29, wherein the authentication information comprises a username and password.

31. A method for authorizing and authenticating a user requesting access to a web server, the method comprising:
receiving an authorization token;
receiving an authentication token; and
wherein a change in the authentication token invalidates the authorization token.

32. The method of claim 31, wherein the change in the authentication token comprises an expiration of the authentication token.

33. The method of claim 31, wherein the change in the authentication token comprises receiving a new authentication token.

34. The method of claim 31, wherein the receiving an authorization token comprises requesting the authorization token from an authorization facility.

35. The method of claim 34, wherein the receiving an authentication token comprises requesting the authentication token from an authentication facility.

36. The method of claim 31, wherein the authorization facility and the authentication facility are incorporated into a central facility.

37. The method of claim 31, wherein the receiving an authorization token comprises requesting the authorization token from an authorization facility, the method further comprising:
upon requesting the authorization token from the authorization facility, being directed to obtain an authentication token from an authentication facility; and
after receiving the authentication token, again requesting the authorization token from the authorization facility.

38. The method of claim 31, wherein the authorization token is protected by a MAC, and wherein inputs for the MAC comprise at least a portion of the authorization token and the authentication token.

39. The method of claim 31, wherein all communication between the content server and the authentication facility involve a user's browser as an intermediary.

40. A method for authorizing and authenticating a user requesting access to a database associated with a web server, the method comprising:
requesting access to the web server;
receiving a redirection from the web server to obtain an authorization from an authorization facility; and
requesting the authorization from the authorization facility, wherein the authorization facility checks to determine if an authentication token exists to permit access to the web server.

41. The method of claim 40, the method further comprising:
receiving a redirection from the authorization facility to obtain the authentication token from an authentication facility;
requesting and receiving the authentication token; and
again requesting the authorization from the authorization facility, wherein the authorization is granted based in part on the authentication token.

42. A method for authenticating a user requesting access to a web server, the method comprising:
receiving a request to authenticate a requestor at a central facility, wherein the request comprises authentication information about the requestor;
using the authentication information to authenticate the requestor;
providing an authentication token to the requestor; and
receiving communication directly from a web server accessed by the requestor using the authentication token.

43. A method for authenticating a user requesting access to a web server, the method comprising:
receiving a request from a requestor at the web server, wherein the requestor has an authentication token provided by a central facility that allows the requestor to access the web server; and
using the authentication token from the requestor to communicate directly with the central facility to access information about the requestor.

44. The method of claim 43, wherein the information about the requestor comprises personal profile information about the requestor.

45. The method of claim 44, wherein communication to the central facility is only allowed where the requestor has an open session with the web server.
